(19) United States
(12) Patent Application Publication
(10) Pub. No.: US 2010/0144209 A1
(43) Pub. Date: Jun. 10, 2010

(54) CONNECTION ELEMENT FOR COMMUNICATIONS AND DATA TECHNOLOGY

(75) Inventors: Ulrich Hetzer, Berlin (DE); Frank Mossner, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/442,843

(22) PCT Filed: Jul. 18, 2007
(86) PCT No.: PCT/EP07/06371

§ 371 Date: Feb. 24, 2010

(30) Foreign Application Priority Data
Sep. 29, 2006 (DE) 10 2006 046 180.0

(51) Int. Cl. H01R 24/00

(52) U.S. Cl. 439/676

(57) ABSTRACT

The invention relates to a connection element for communications and data technology, comprising a housing and connection contacts, which are arranged in the housing, wherein the housing has electrically and/or magnetically conductive parts, wherein the surface of the housing is made completely of electrically and/or magnetically nonconductive material, and to a method for producing a connection element.

The invention relates to a connecting element for communication and data technology, comprising a housing and connecting contacts which are arranged in the housing, and to a method for production of a connecting element.

Connecting elements such as these for telecommunication and data technology are, for example, female connectors and male connectors to which the conductors in a cable can be connected. As transmission rates increase, as in the case of CAT6 or 10 Gbit/s Ethernet, the requirements for the connecting elements are also becoming more stringent. In particular, the so-called “alien cross talk” between adjacent connecting elements in this case has negative effects on the transmission behavior.

DE 196 04 564 C1 discloses a connecting socket for a data network, having a metallic housing lower part which has a stand surface, which is designed for mounting flat on a wall, having a metallic housing upper part and having a circuit board which is enclosed between the housing upper part and the housing lower part and is fitted with at least one female data connector and a plurality of wire connecting terminals, to which the individual conductors in a multicore data cable can be connected. In this case, a ground connection to the board is produced via the metallic lower part, and can then be used, for example, to connect the cable shield to the housing ground. A covering plastic cap is then placed over the housing upper part and the housing lower part.

However, unshielded connecting elements are preferred in some cases, for various reasons.

The invention is thus based on the technical problem of providing a connecting element for unshielded applications in telecommunication and data technology, which has a better transmission behavior at high transmission rates.

The technical problem is solved by the subject matter of the features of claim 1 or 8. Further advantageous refinements of the invention are specified in the dependent claims.

For this purpose, the connection element for communication and data technology comprises a housing and connecting contacts which are arranged in the housing, in which the housing has electrically conductive and/or magnetically permeable parts, with the surface of the housing being composed entirely of electrically non-conductive and/or magnetically non-permeable material. This means that the electrically conductive parts and/or magnetically permeable parts effectively suppress interference fields from the exterior and the radiated emission of interference radiation, while at the same time, however, avoiding undesirable coupling between adjacent housings. Furthermore, this also prevents electrical and/or magnetic shorts between the housing and the connecting contacts which are arranged in the housing. It should be noted that magnetically non-permeable means that the surface has low relative permeability, which is not much greater than unity.

In one preferred embodiment, the housing is composed of a non-conductive material, preferably plastic, into which metal parts and/or ferrites are introduced. The metal parts may in this case be extrusion coated, or else may be inserted into the housing retrospectively. The ferrites are preferably introduced into the plastic as a filling. In addition to the metal parts, other highly conductive materials such as graphite or metallized plastic particles can also be used. The process of filling with particles during spraying normally results in an electrically conductive and/or magnetically permeable surface so that a cover is then required here, for example with a covering lacquer, as will be described for other embodiments in the following text.

In a further preferred embodiment, the housing is formed from metal, to which an electrically insulating lacquer covering or a covering lacquer is applied. The housing may also be formed from two or more parts, in which case one part may be composed of metal and another part of plastic. The housing or a housing part may likewise be composed of ferrite material, which then has a lacquer covering or a covering lacquer.

In a further preferred embodiment, the housing is composed of a preferably non-conductive plastic, which has a metal and/or ferrite coating in places, to which an electrically insulating and/or magnetically non-permeable lacquer covering or covering lacquer is applied. The coating may be sprayed on, for example as a conductive lacquer, or may be applied electrochemically or by vacuum plating. By way of example, the ferrite coating may be in the form of a wound strip.

In a further preferred embodiment, the housing is sprayed from two plastics, in which case the housing is preferably also composed of polycarbonate and ABS. ABS can be electroplated considerably more easily than polycarbonate. In this case, the metallization is preferably applied to the plastic by means of electroplating, since the resistance values which can be achieved in this way are lower than that which can be achieved by means of the vacuum plating or similar methods.

In one preferred embodiment, the connecting element is in the form of a female connector or male connector, in particular in the form of an RJ45 female connector or male connector.

In one alternative embodiment, the connecting element for communication and data technology comprises a housing and connecting contacts which are arranged in the housing, in which the housing is electrically conductive and/or magnetically permeable at least in places on the surface, or has an electrically conductive and/or magnetically permeable coating at least in places, with both the inner surface and the outer surface of the housing being electrically conductive and/or magnetically permeable in places, or having an electrically conductive and/or magnetically permeable coating, with at least the electrically conductive and/or magnetically permeable areas on the outer surface being coated with an electrically non-conductive and/or magnetically non-permeable covering lacquer. Once again, this results in the electrically conductive and/or magnetically permeable parts effectively suppressing interference fields from the exterior and the radiated emission of interference radiation, while at the same time, however, avoiding undesirable coupling between adjacent housings. In this case, the inner surface of the housing need not be covered, or need not be completely covered, provided that other measures are taken to ensure the avoidance of undesirable couplings or shorts. On the other hand, however, this embodiment allows the utilization of desired couplings between the contacts and the magnetically permeable and/or electrically conductive areas on the inner surface of the housing, in order to influence the transmission behavior in this way. In this case, it should be clarified that the wording that the housing is electrically conductive and/or magnetically permeable in places on the surface, relates to areas, that is to say there are at least subareas which are electrically conductive and/or magnetically permeable. The outer surface is formed by those surfaces which form the external contour of the housing when the latter is in its assembled state, so that the surfaces which define the holder for the plug connector thus in their own right include the inner surface, although these are also preferably coated with the covering lacquer. With regard to the rest of the design, reference can otherwise be made in full to the previous statements, in particular the embodiments described in the dependent claims.

The invention will be explained in more detail in the following text using one preferred exemplary embodiment. In the figures:

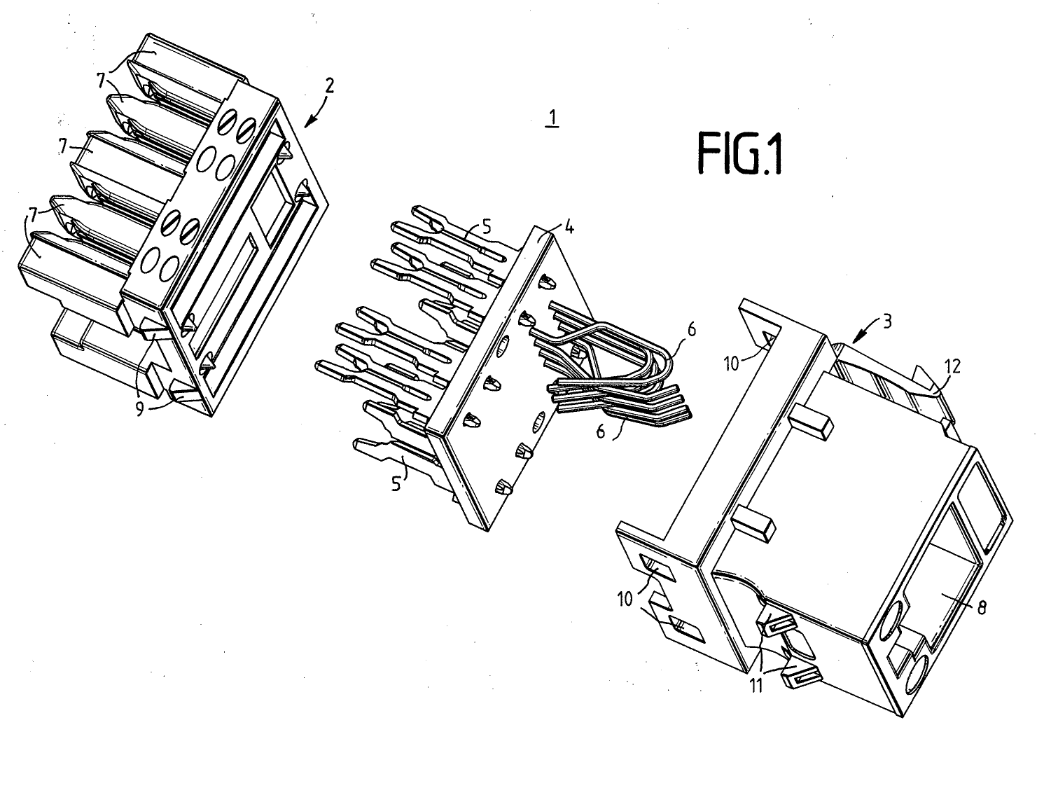

FIG. 1 shows an exploded illustration of an RJ-45 female connector,

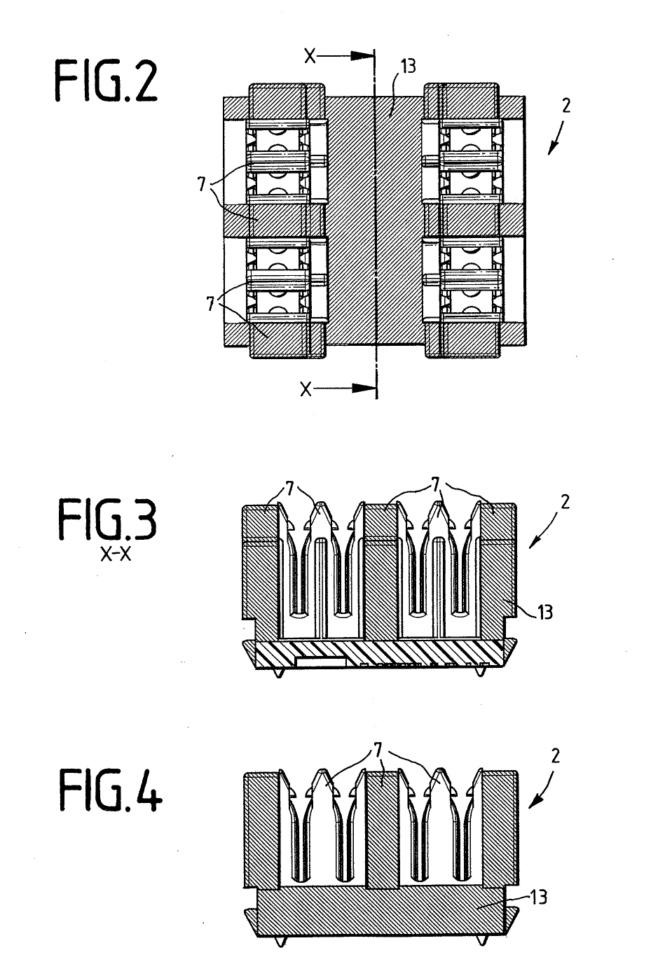

FIG. 2 shows a plan view of a first housing part,

FIG. 3 shows a section illustration along the section X-X in FIG. 2,

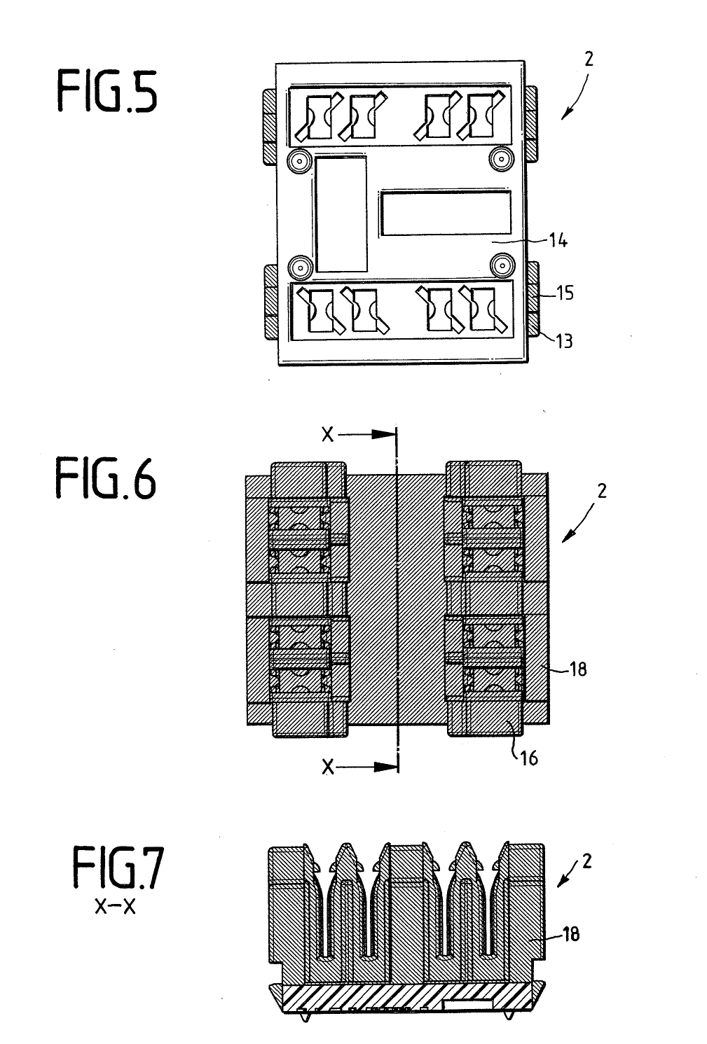

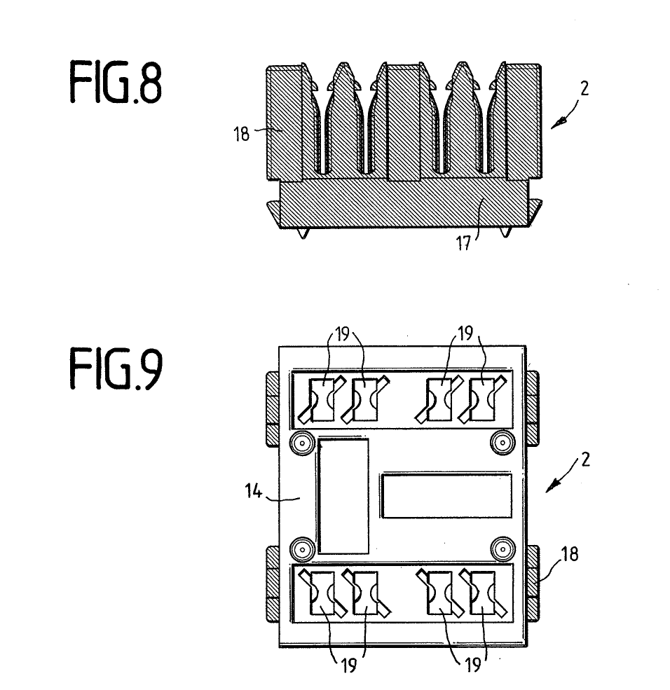

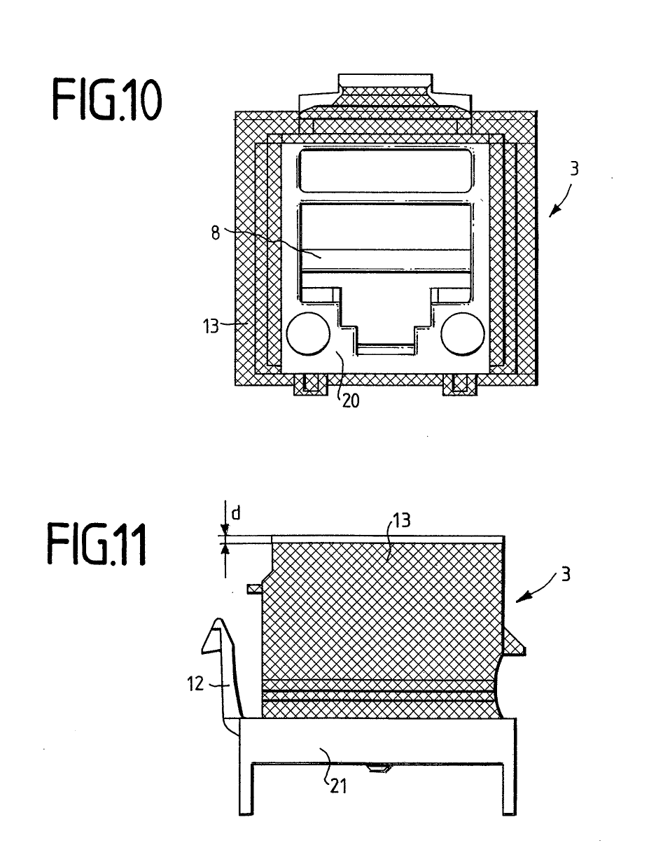

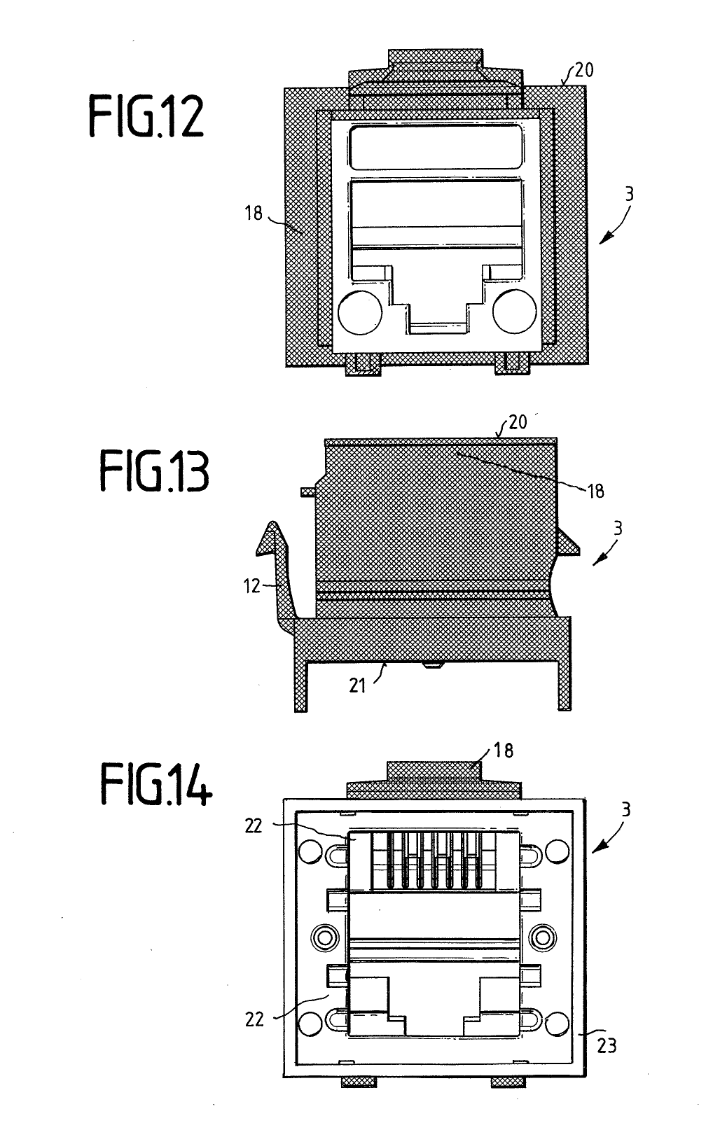

FIG. 4 shows a side view of the first housing part,

FIG. 5 shows a view from underneath of the first housing part,

FIG. 6 shows a plan view of the first housing part,

FIG. 7 shows a section illustration along the section X-X in FIG. 6,

FIG. 8 shows a side view of the first housing part,

FIG. 9 shows a view from underneath of the first housing part,

FIG. 10 shows a plan view of the second housing part,

FIG. 11 shows a side view of the second housing part,

FIG. 12 shows a plan view of the second housing part,

FIG. 13 shows a side view of the second housing part, and

FIG. 14 shows a view from underneath of the second housing part.

FIG. 1 shows an exploded illustration of an RJ45 female connector 1, which comprises a first housing part 2 and a second housing part 3. Furthermore, the RJ45 female connector 1 comprises a printed circuit board 4 on which eight insulation-displacement terminal contacts 5 and eight spring or RF contacts 6 are arranged. The insulation-displacement terminal contacts 5 are in this case arranged in pairs. Some of the spring contacts 6 are bent with respect to one another, thus resulting in improved close crosstalk between the spring contacts 6. In the assembled state, the insulation-displacement terminal contacts 5 are arranged between clamping ribs 7 on the first housing part 2. In a corresponding manner, the spring contacts 6 project into a holder 8 in the second housing part 3, so that contact can be made with them by means of an RJ45 male connector, which is not illustrated. The first housing part 2 and the second housing part 3 are latched to one another, with the latching tabs 9 on the first housing part 2 latching into the latching holders 10 in the second housing part 3. The RJ45 female connector 1 can then be latched, for example, to a front panel by means of two latching tabs 11 and a latching clip 12.

FIG. 2 shows a plan view of the first housing part 2, with the shaded areas representing an electrically conductive coating 13 while, in contrast, the white areas are designed to be electrically non-conductive. In this case, in particular, those parts in the immediate vicinity of the insulation-displacement terminal contacts are electrically non-conductive. In the case of the thick clamping ribs 7, the edge areas are in this case electrically non-conductive, with the central areas having the electrically conductive coating 13. This can also be seen in FIGS. 3 and 4, which show that the electrically conductive and electrically non-conductive areas also extend over the side areas. The electrically conductive coating 13 may, for example, be formed by a conductive lacquer which is sprayed onto the housing part 2, or is applied in some other way, with the housing part 2 itself being composed of an electrically non-conductive plastic. Alternatively, the coating 13 can be applied by electroplating or vacuum plating. It should also be noted that, as can be seen from FIG. 2, the distance between two insulation-displacement terminal contacts 5 of one pair is less than the distance between insulation-displacement terminal contacts 5 of different pairs, which reduces the close crosstalk. The lower face 14 of the first housing part 2, from which the insulation-displacement terminal contacts 5 are also introduced, does not have any electrically conductive coating 13, apart from the reset areas 15, as can be seen in FIG. 5.

FIGS. 6 to 9 now show the next method step, in which an electrically non-conductive covering lacquer 18 is applied to the upper face 16 and to the side parts 17 of the housing part 2, as is illustrated in shaded form in FIGS. 6 to 9. Since the lower face 14 does not have any electrically conductive coating 13, no covering lacquer 18 is required. However, there is no problem if covering lacquer 18 nevertheless reaches the lower face 14, provided only that the guides in the chambers 19 for the insulation-displacement terminal contacts are not disturbed.

The method for the second housing part 3 is illustrated in a corresponding manner in FIGS. 10 and 11 as well as FIGS. 12 to 14. In this case, FIGS. 10 and 11 once again show the electrically conductive coating 13 in shaded form. As can be seen in FIG. 10, the area of the holder 8 has no electrically conductive coating 13. The upper face 20 is preferably excluded from the electrically conductive coating over a thickness d of, for example, 0.3 to 0.7 μm. The lower area 21 as well as the latching hooks 12 are likewise free of the electrically conductive coating 13. A covering lacquer 18 is then applied again, with the area of the holder 8 on the upper face 20 being excluded from the covering lacquer 18. The lower face 22 is likewise free of covering lacquer 18, in which case edge areas 23 can be excluded from this, that is to say they may have covering lacquer 18. The covering lacquer 18 is in this case illustrated in shaded form in FIGS. 12 to 14.

### LIST OF REFERENCE SYMBOLS

1 RJ45 female connector

2 First housing part

3 Second housing part

4 Printed circuit board

5 Insulation-displacement terminal contacts

6 Spring or RF contacts

7 Clamping ribs

8 Holder

9 Latching tab

10 Latching holder

11 Latching tab

12 Latching clip

13 Electrically conductive coating

14 Lower face

15 Reset areas

16 Upper face

17 Side part

18 Covering lacquer

19 Chamber

20 Upper face

21 Lower area

22 Lower face

23 Edge area

1. A connecting element for communication and data technology, comprising a housing and connecting contacts which are arranged in the housing, wherein the housing has electrically conductive and/or magnetically permeable parts, with the surface of the housing being composed entirely of electrically non-conductive and/or magnetically non-permeable material.

2. The connecting element as claimed in claim 1, wherein the housing is composed of a non-conductive plastic into which metal parts and/or ferrites are introduced.

3. The connecting element as claimed in claim 1, wherein the housing is formed from metal and/or ferrite material, on which a covering lacquer is applied.

4. The connecting element as claimed in claim 1, wherein the housing is composed of a plastic which in places has an electrically conductive coating and/or a ferrite coating, to which a covering lacquer is applied.

5. The connecting element as claimed in claim 4, wherein the housing is sprayed from two plastics.

6. The connecting element as claimed in claim 5, wherein the housing is composed of a polycarbonate and ABS.

7. The connecting element as claimed in claim 1, wherein the connecting element is in the form of a female connector or male connector.

8. A connecting element for communication and data technology, comprising a housing and connecting contacts which are arranged in the housing, wherein the housing is electrically conductive and/or magnetically permeable at least in places on the surface, or has an electrically conductive and/or magnetically permeable coating at least in places, with both the inner surface and the outer surface of the housing being electrically conductive and/or magnetically permeable in places, or having an electrically conductive and/or magnetically permeable coating, with at least the electrically conductive and/or magnetically permeable areas on the outer surface of the housing being coated with an electrically non-conductive and/or magnetically non-permeable covering lacquer.

9. A method for production of a connecting element as claimed in claim 4, wherein an electrically conductive coating is applied at least in places to the housing, and a covering lacquer is applied to this coating.
